(19) United States
(12) Patent Application Publication
(10) Pub. No.: US 2010/0058249 A1
(43) Pub. Date: Mar. 4, 2010

(54) SYSTEM AND METHOD FOR PROVIDING A GRAPHICAL USER INTERFACE FOR PREDICTION MARKETS

(75) Inventors: Prasenjit Sarkar, Santa Clara, CA (US); Sharad Goel, New York, NY (US); David M. Pennock, Monroe Township, NJ (US); Daniel Reeves, New York, NY (US); Yiling Chen, New York, NY (US); Cong Yu, New York, NY (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/201,526

(22) Filed: Aug. 29, 2008

(51) Int. Cl. G06F 3/048

(52) U.S. Cl. 715/856

(57) ABSTRACT

A system for providing a probability output and receiving an input includes a processor and a memory unit in communication with the processor. The memory has processor-executable instructions that configure the processor to provide a user interface having the probability output, wherein the probability output is in a graphical form and receives an input from the user via the user interface, wherein the user provides the input by marking portions of the graphical form of the probability output.

### BACKGROUND

1. Field of the Invention

The invention relates to systems and methods for providing a probability output and receiving an input from a user via a graphical user interface and more specifically to systems and methods for providing a graphical user interfaces for prediction markets.

2. Description of the Known Art

As it is well known, electronic network devices, such as personal computers, mobile phones and personal digital assistants, contain a display device capable of displaying text and graphics. These display devices are capable of displaying a variety of data including probabilities that an event will occur. Prediction markets generate aggregate estimates of the likelihood of future events. Typically, the number of possible outcomes for a prediction market is relatively small. Because the number of outcomes is relatively small, these estimates can be easily displayed. Further, selecting data from these estimates of the prediction markets is relatively easy as there is little data to select.

However, combinational markets, in contrast, deal with a large number of outcomes. Often these outcomes may range from fifty outcomes to more than one million outcomes. Moreover, persons viewing this data must need to understand the potential likelihood that these outcomes are likely to occur.

As it is well known, electronic network devices also contain input devices, so that the user can input data, allowing the user to interact with the electronic network device. Because of the sheer number of the outcomes displayed in combinational markets, it is often difficult for persons to select data via an input device. This can be especially difficult when the user is attempting to select data they believe is most likely to occur, as this data may include numerous outcomes. As stated previously, combinational markets may have millions of points of data and selecting these millions of points of data can be extremely time consuming and tedious.

### BRIEF SUMMARY

In overcoming the drawbacks of the prior art, a system and method for providing a probability output and receiving an input from a user via a graphical user interface is described. The system is typically a general purpose computer having a processor and a memory unit in communication with the processor. Generally, the memory unit contains instructions to configure the processor to execute the method for providing the probability output and receiving the input from the user via the graphical user interface.

The instructions configure the processor to provide a user interface having the probability output. This probability output is generally in a graphical form and is based on a probability that an event will occur. The processor is further configured to receive an input from the user via the graphical user interface. However, this input is provided by the user by marking portions of the graphical form of the probability output. In other words, the user can select the data that the user believes is likely to be true by simply marking the graphical form and submitting it to the processor. Thereafter, the processor may update the graphical form based on the input received from the user.

Further objects, features, and advantages of this invention will become readily apparent to persons skilled in the art after review of the following description, with reference to the drawings and claims that are appended to and formed part of this specification.

### BRIEF DESCRIPTION OF THE DRAWINGS

FIG. 1 is a block diagram of a system for providing a probability output and receiving an input;

FIG. 2 is a block diagram of a general purpose computer capable of executing the method for providing the probability output and receiving the input from the user;

FIG. 3 is a flow chart of the method for providing the probability output and receiving the input from the user;

FIG. 4 illustrates one embodiment of the graphical form of the probability output; and

FIG. 5 discloses a second embodiment of the graphical form of the probability output.

### DETAILED DESCRIPTION

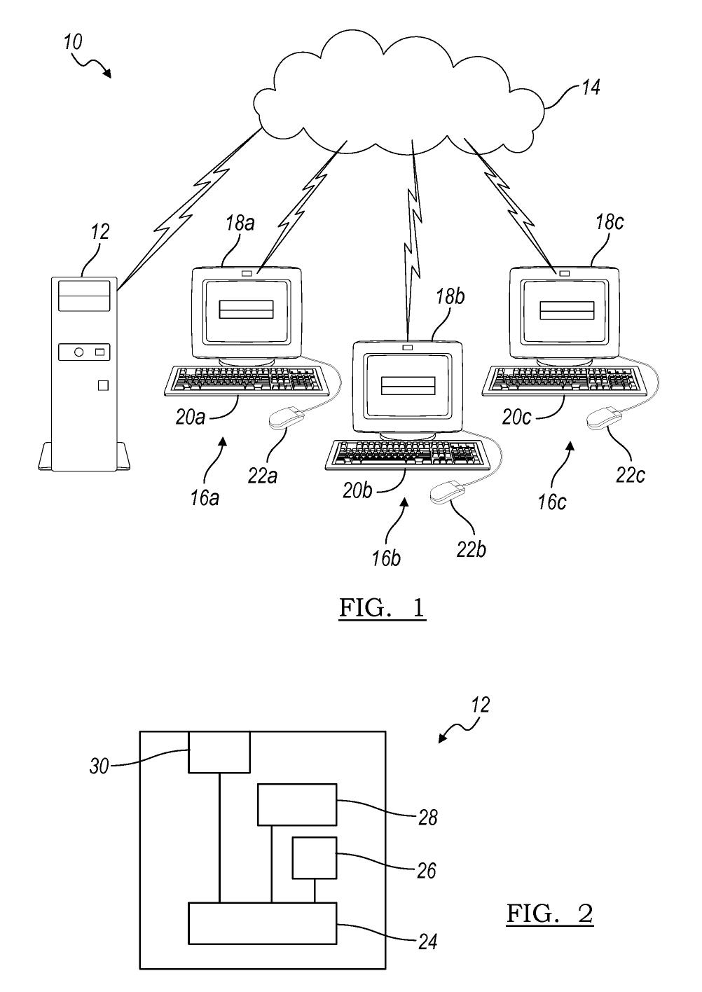

Referring to FIG. 1, a system 10 for providing the probability output to a user and receiving an input from the user is shown. The system 10 includes a server 12 capable of being in communication with a distributed network 14, such as the Internet. Of course, it should be understood that the server 12 may be a single server as shown or may be a plurality of servers. The server 12 will be described in more detail in the paragraphs that follow.

The system 10 also includes user computers 16a, 16b, and 16c. Like the server 12 the user computers 16a, 16b, and 16c are also capable of being connected to the network 14. The use computer 16a, 16b, and 16c include display devices 18a, 18b, and 18c. The user computer 16a, 16b, and 16c also include input devices. These input devices may be in the form of keyboards 20a, 20b, and 20c. Additionally or alternatively, the input devices may be an analog input device, such a mouse, as shown by mice 22a, 22b, and 22c.

However, it should be understood that user computers 18a, 18b, and 18c may take a variety of different forms. In FIG. 1, the user computers 18a, 18b, and 18c are displayed as general purpose desktop computers. However, the user computers 16a, 16b, and 16c may be any form of electronic device capable of being connected to the network 14. These devices may include mobile phones, personal digital assistants, vehicle navigation devices, set top cable box or video game machine connected to a display, or any other electronic device having both a display and some form of input device.

Also, it should be understood that although the input devices are shown in FIG. 1 as a traditional mouse and keyboard. However, the input devices may take multiple forms. For example, the input device may be a simplified keyboard, such as those found on mobile phones, a voice input device or any one of the numerous analog input devices such as a trackball, touch pad, joystick, or a game pad.

Finally, it should be understood that although only three user computers 16a, 16b, and 16c are shown, there may be any number of user computers connected to the network 14. In fact, there may be only one user computer or may be millions of user computers (or more) connected to the network 14.

Since the user computers 18a, 18b, and 18c are connected to the network 14 they are also in communication with the server 12. The server 12 is able to send information to the user computers 16a, 16b, and 16c via the network 14 and this data can be displayed on the display of devices 18a, 18b, and 18c.

When data provided from the server 12 is sent to the user computers 16a, 16b, and 16c, the data may be displayed on the display devices 18a, 18b, and 18c using a program capable of displaying data. Generally, this program may be a web browser capable of viewing numerous websites on the World Wide Web or may be a dedicated program capable of only interfacing with the server 12.

Referring to FIG. 2, a more detailed illustrating of the server 12 is shown. The server 12 includes as its primary component a processor 24. The processor 24 is in communication with the memory unit 26. The memory unit 26 includes processor executable instructions that can be executed by the processor 24. Of course, the memory unit 26 and processor 24 may be separate components as shown, but may also be one single integrated component. Also, although the processor 24 is shown as a single processor, the processor 24 may be a multi-core processor or may even be a plurality of processors.

Also in communication with the processor 24 are a storage unit 28 and a network interface 30. The storage unit 28 is generally a magnetic storage device, such as a hard disk, but may be any device suitable of storing electronic data. The network interface 30 is generally well known in the art and allows the server 12, and therefore the processor 24, to be in communication with the network 14 of FIG. 1.

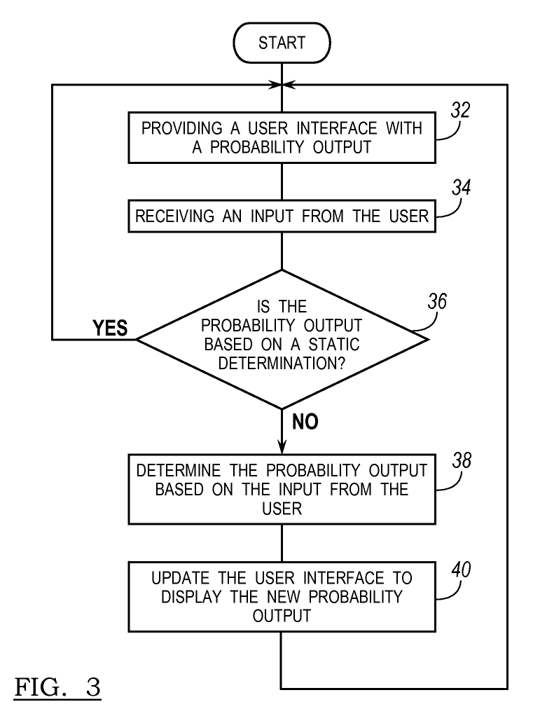

Referring to FIG. 3, a method for providing a probability output to the user and receiving an input from the user is shown. This method is expressed in the processor executable instructions stored in the storage unit 26 of FIG. 2. As such, the processor 24 of FIG. 2 is capable of executing these instructions.

The method begins with step 32, where the processor is configured to provide a user interface with a probability output to the user. This is accomplished by transmitting information from the server 12 to the user computers 16a, 16b, and 16c. In turn, these user computers 16a, 16b, and 16c transmit the probability output to the display devices 18a, 18b, and 18c.

In step 34, the server 12 receives an input from the user of one of the computers 16a, 16b, and 16c. Thereafter, in step 36, a determination is made if the probability output is based on a static determination. If the answer is yes, the method returns to step 32. If the answer is no, the method continues to step 38.

In step 38, a determination is made to calculate the probability output based on the input from the user. As it is well known in gambling, the probability changes as the number of bets outcome changes. Therefore, if most of the bets favor one outcome, the probability output will be updated to indicate that outcome. In like manor, if few bets are going to other outcomes, the probability output will be updated to reflect that these outcomes are less likely to occur. Therefore, in step 40 the user interface that is displayed on the display devices 18a, 18b, and 18c is updated to reflect the new calculated probability output based on the input received from the user in step 34.

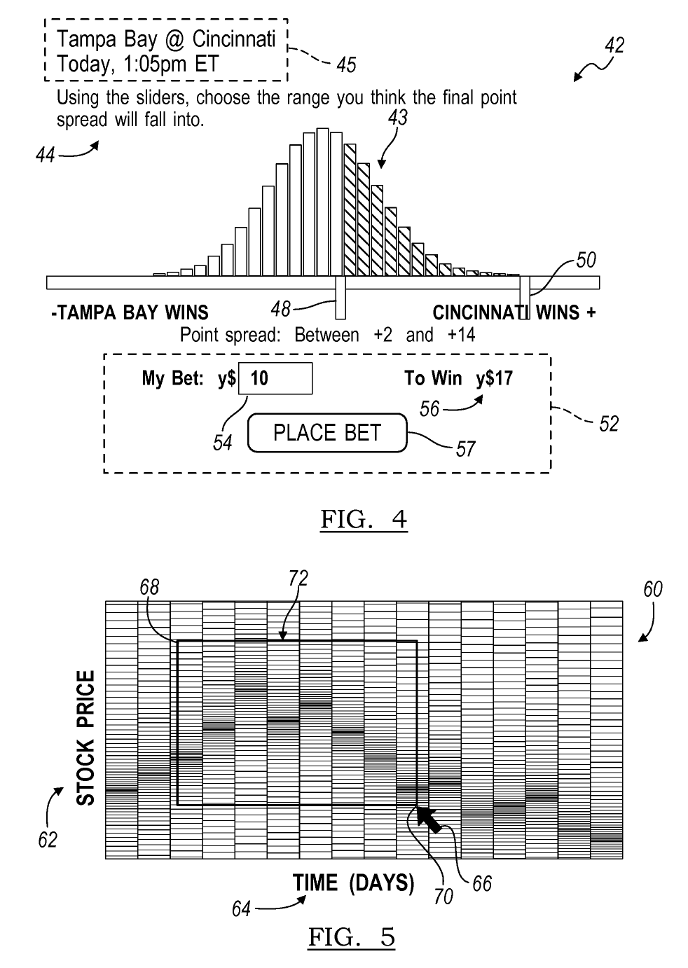

Referring to FIG. 4, an example of the probability output 42 is shown. As it is obvious, the probability output reflects a graphical form, in this case, a histogram 43. Here, this histogram represents a probability output of a sporting event. The participants of the sporting event and the time in which the sporting event takes place are shown in information block 45. Below the information block 45, instructions 44 are provided such that the users of the user computer 16a, 16b, and 16c can understand how to provide their inputs to the server 12.

In this situation the histogram 46 generally represents a bell-shaped curve, representing a point spread. Sliders 48 and 50 are placed near the bottom of the histogram 43. These sliders 48 and 50 can be adjusted by the users of the user computers 16a, 16b, and 16c by utilizing the input devices, such as the mice 22a, 22b, and 22c. In this situation, the user has selected a point spread having a range between two and fourteen points, favoring one of the participants, in this case Cincinnati, to win between two and fourteen points.

As stated previously, the histogram represents a bell shaped curve, and that this bell shaped curve generally represents the likelihood of how much a participant will win by. In addition to the probability output, there is a betting location 52. The betting location 52 has an input area 54 for inputting a monetary amount the user would like to bet. Additionally, the betting area 52 has an output area 56 indicating what the user will win if their point spread is correct. Finally, betting area 52 includes a place bet button 57 which finalizes the transaction of the user.

Once the user finalizes the transaction, the method may determine, as stated in step 36 of FIG. 3, that this probability output is not a static determination and should be updated. Therefore, as previously described in step 38 of FIG. 3, the method will determine the probability output based on the input from the user and, as described in step 40, and update the user interface to display the new probability output. Therefore, if the users of user computers 16a and 16b select one point spread based on a similar probability output, a later bet placed by the user of user computer 16c will receive a probability output that has changed based on the previous bets placed by the users of computers 16a and 16b.

Referring to FIG. 5, another graphical form of a probability output 60 is shown. Here, this probability output is a two dimensional image that represents a trajectory bet. As can be seen, the graphical form 60 has a y axis 62 of stock price and an x axis 64 representing time in days. Also can be seen by in the graphical form 60 is that there is a shading between two colors. The darker colors (blueish) indicate that an output is least likely to occur and the lighter colors (redish) indicate that an output is more likely to occur.

There is a pointer 66 that is controlled generally by the mice 22a, 22b, and 22c of the user computer 16a, 16b, and 16c respectively. Here, the user can select data that the user appears most likely to occur by simply moving the pointer 66 to a first corner 68, and dragging from that first corner 68 to a second corner 70. A rectangle window 72 will be defined between the first corner 68 and the second corner 70. The data within this window 70 will then be the data that the user believes to be most probable to occur. Similarly, this data can then be provided to the server 12 where the server 12 can update this graphical form to represent that this user believes that these events will occur at the time they will occur.

As a person skilled in the art will readily appreciate, the above description is meant as an illustration of implementation of the principles of this invention. This description is not intended to limit the scope or application of this invention in that the invention is susceptible to modification, variation, and change, without departing from the spirit of this invention, as defined in the following claims.

1. A method for providing a probability output and receiving an input, the method comprising the steps of:
providing a user interface having the probability output, wherein the probability output is in a graphical form;
wherein the probability output is based on a probability; and
receiving an input from the user via the user interface, wherein the user provides the input by marking portions of the graphical form of the probability output.

2. The method of claim 1, wherein the probability is based on a static pre-calculated determination.

3. The method of claim 1, wherein the probability is based on a dynamic determination.

4. The method of claim 3, further comprising the step of updating the graphical form of the probability output every time an input is received from the user.

5. The method of claim 3, wherein the dynamic determination is calculated based on inputs from a plurality of users, wherein the inputs from the plurality of users are used to determine the probability.

6. The method of claim 1, wherein the graphical form of the probability output is a histogram having a range.

7. The method of claim 6, wherein the range is a point spread for a sporting event.

8. The method of claim 1, wherein the graphical form of the probability output is a two dimensional image representing two dimensional data, the two dimensional image having portions colored with a first color and portions colored in a second color, wherein the first color indicates portions of the graphical form containing data having the probability of being more likely to be true and the second color indicates portions of the graphical form containing data having the probability of being more likely to be false.

9. The method of claim 8, wherein the graphical form of the probability output includes portions being a mix of colors between and including the first color and the second color, the mix of colors indicating portions of the graphical form containing data having a probability to be true in portions of the graphical form colored most closely to the first color and false in portions of the graphical form colored most closely to the second color.

10. The method of claim 8, wherein the two dimensional image represents a trajectory bet.

11. A system for providing a probability output and receiving an input, the system comprising:
a processor;
a memory unit in communication with the processor, the memory unit having processor executable instructions;
wherein the instructions configure the processor to execute the following steps:
provide a user interface having the probability output, wherein the probability output is in a graphical form;
wherein the probability output is based on a probability; and
receive an input from the user via the user interface, wherein the user provides the input by marking portions of the graphical form of the probability output.

12. The system of claim 11, wherein the probability is based on a static pre-calculated determination.

13. The system of claim 11, wherein the probability is based on a dynamic determination.

14. The system of claim 13, wherein the processor is further configured by the instructions to update the graphical form of the probability output every time an input is received from the user.

15. The system of claim 13, wherein the dynamic determination is calculated based on inputs from a plurality of users, wherein the inputs from the plurality of users are used to determine the probability.

16. The system of claim 11, wherein the graphical form of the probability output is a histogram having a range.

17. The system of claim 16, wherein the range is a point spread for a sporting event.

18. The system of claim 11, wherein the graphical form of the probability output is a two dimensional image representing two dimensional data, the two dimensional image having portions colored with a first color and portions colored in a second color, wherein the first color indicates portions of the graphical form containing data having the probability of being more likely to be true and the second color indicates portions of the graphical form containing data having the probability of being more likely to be false.

19. The system of claim 18, wherein the graphical form of the probability output includes portions being a mix of colors between and including the first color and the second color, the mix of colors indicating portions of the graphical form containing data having a probability to be true in portions of the graphical form colored most closely to the first color and false in portions of the graphical form colored most closely to the second color.

20. The system of claim 18, wherein the two dimensional image represents a trajectory bet.
